(19) United States
(12) Patent Application Publication
(10) Pub. No.: US 2012/0210267 A1
(43) Pub. Date: Aug. 16, 2012

(54) OPERATING HOUR INTERACTIVE DYNAMIC SYSTEM AND DISPLAY

(76) Inventor: Gregory Lawrence Birch, Port Angeles, WA (US)

(21) Appl. No.: 13/459,479

(22) Filed: Apr. 30, 2012

Related U.S. Application Data
(63) Continuation-in-part of application No. 12/357,082, filed on Jan. 21, 2009.
(60) Provisional application No. 61/063,177, filed on Feb. 1, 2008.

(51) Int. Cl. G06F 3/048

(52) U.S. Cl. 715/772

(57) ABSTRACT

An interactive dynamic real-time display of operating hour information in a graphic format to users of internet linked computers and devices comprising a grid model representing a set of potential operating hours of an enterprise, a depiction of shaded regions representative of the enterprise's operating hours, an icon depicting a current operating status for the enterprise, the position of the icon representing the current date and clock time relative to the shaded regions. A graphics generator prepares a presentation of the grid model and icon according to the data as correlated to the current date and clock time. A user viewing the presentation is capable of making a determination of the current operating status of the enterprise upon viewing the position of the icon relative to the shaded regions without reference to time zones, a location of the enterprise, the user's location, a calendar, a date or a clock.

### CROSS REFERENCE TO RELATED APPLICATIONS

This is a Continuation-In-Part Application claiming priority under 35 USC 120 of U.S. patent application Ser. No. 12/357,082 filed Jan. 21, 2009 entitled “Operating Hour Interactive Dynamic System and Display,” said application claiming priority under 35 USC 119(e) of Provisional Patent Application Ser. No. 61/063,177 filed Feb. 1, 2008, entitled “Operating Hour Index, Search Software for Selected Entity With Results Displayed On Web, PC and Mobile Devices”, said applications hereby incorporated by reference in their entirety.

### FIELD OF THE INVENTION

This invention relates generally to online business directories, and more particularly to an interactive system for dynamic graphic display of operating hour information in real time to users of internet linked computers and devices.

### BACKGROUND OF THE INVENTION

The data for operating hours for entities ranging from self-employed individuals, to businesses, institutions, public and non-public entities, local state and federal government agencies, and the like, is increasingly dynamic in nature. “Typical” operating hours of 9 a.m. to 5 p.m., Monday through Friday, are outdated and can no longer be assumed. This is particularly the case with small business operations. Small business hours are fluid. The company may desire to structure operating hours around employee availability, around varying weather conditions during the year, around holidays, vacation times, and the like. In addition, with the growing global economy, business is increasingly carried out across large distances necessitating increased communications across different time zones.

Historically, options for inquiring about operating hours were limited to direct contact inquiries via telephone or physically visiting a business. Current options include researching paper telephone directories for ads that might include operating hour information or searching online for operating information on an entity's website.

On-line directories are in their infancy and are akin to paper directories in their scope of information. No centralized on-line directories providing operating hour information currently exist. Operating hour information provided in an on-line directory format would be text-based requiring the viewer to: 1) read the text-based information; 2) compare the text-based information to current date and time information from an independent source; and, 3) determine, based thereon, whether the entity is currently open or closed.

In the case of a centralized directory, if time is expressed in a manner not accustomed to by the viewer (such as military time versus regular time), the viewer will have difficulty understanding and making calculations based on the information. In addition, centralized directories are presented in a particular language using a particular numeric system. Consequently, the operating hours of a centralized on-line directory would likely be expressed in a manner that is not globally or universally understood, causing confusion for some viewers and requiring translation steps. In addition, reading text-based information takes time and effort where the font size is small, such as on hand-held phones and other mobile devices.

Moreover, if an entity is in a different time zone than the viewer of a centralized directory, the viewer must further calculate the difference in time between the time zone in which the person is located, on the one hand, and the time zone in which the entity is located, on the other hand, and either add or subtract those hours from the final calculation to determine whether the entity is open for business. This requires that the viewer be familiar with the local time zone of the entity which he/she wants to contact as compared to the time zone for the viewer's current location. The viewer also must determine which time zone the operating hour information displayed in text format in the on-line directory is based upon. This could lead to further confusion. These calculations would be even more difficult if the person is traveling, such as by airplane, as the operating hour information being researched would be even more dynamic.

Accordingly, there is a need in the art for an interactive system with global application that provides specific and dynamic (real time) information about operating hours to persons world wide and displays the information in a universally understood non-text-based manner that is readily visible and understood without reference to time zones, a location of the enterprise, a location of the user, a calendar, a date or a clock.

### THE INVENTION

### Summary of the Invention

The inventive Operating Hour Interactive Dynamic System and Display of this application comprises an apparatus for graphically displaying dynamic operating hour data comprising a grid model to graphically represent a set of potential operating hours of an enterprise, a depiction of shaded regions superimposed on the grid model with each region distinguished from others by color or pattern or other distinguishing feature, and each region representative of at least one operating hour. An icon depicts a current operating status for the enterprise. The position of the icon on the grid model represents the current date and clock time relative to the shaded regions, and further represents a comparison of the operating hour data for the enterprise located in a first time zone to a location of a user in a second time zone. A sensor interface receives the operating hour data. A graphics generator prepares a presentation of the grid model and icon according to the data as correlated to the current date and clock time. A user viewing the presentation is capable of making a determination of the current operating status of the enterprise upon viewing the position of the icon relative to the shaded regions without reference to time zones, a location of the enterprise, the user's location, a calendar, a date or a clock.

The grid model may comprise an x-axis and a y-axis, the x-axis comprising a series of 7 regions representative of days in a week, and the y-axis comprising a series of 24 regions representative of hours in a day. The icon may comprise a circular dot distinguished from the shaded regions by color or pattern or other distinguishing feature. The graphics generator may comprise an interface for an end user to select, receive and analyze user preferred display data such as a list of “favorites” to automatically refer to each time the grid is presented.

The invention further comprises a non-transitory computer readable storage media containing a program to perform operations to graphically display dynamic operating hour data and a computer implemented method of graphically displaying dynamic operating hour data, comprising operations of: 1) providing a grid model to graphically represent a set of potential operating hours of an enterprise as follows: a depiction of shaded regions superimposed on the grid model, each region distinguished from others by color or pattern or other distinguishing feature, each region representative of at least one operating hour; an icon depicting a current operating status for the enterprise, wherein a position of the icon on the grid model is representative of a current date and clock time relative to the shaded regions, said position further representative of a comparison of the operating hour data for the enterprise located in a first time zone to a location of a user in a second time zone; 2) receiving operating hour data time from a sensor interface; and, 3) operating a graphics generator to prepare a presentation of the grid model and icon according to the operating hour data as correlated to the current date and clock time, consistent with the first time zone.

The method may further comprise the step of superimposing the presentation of the grid model and icon on a map display, a position of said presentation proximate a location for the enterprise on the map. The method may also comprise the step of superimposing a suggested travel route on a map display, the route determined by a comparison of the location of the user, on the one hand, and a location and a set of remaining operating hours for one or more selected enterprises for the current day of the week and clock time, on the other hand.

### BRIEF DESCRIPTION OF THE DRAWINGS

The invention is described in more detail with reference to the attached drawings, in which:

FIG. 1 is a diagram of an exemplary enterprise interface;

FIG. 2 a flow diagram for a method of entering data on the enterprise interface;

FIG. 3 is a diagram of an exemplary graphics interface;

FIG. 4 is a diagram of an alternate exemplary graphics interface;

FIG. 5 is a diagram of an alternate exemplary graphics interface;

FIG. 6 is a flow diagram for a method for an end user to access and view operating hour data;

FIG. 7 is a block diagram of the system configuration; and,

FIG. 8 is a diagram of an errand running display superimposed on a map.

### DETAILED DESCRIPTION OF THE ILLUSTRATIVE EMBODIMENT

The following detailed description illustrates the invention by way of example, not by way of limitation of the scope, equivalents or principles of the invention. This description will enable one skilled in the art to make and use the invention, and describes several embodiments, adaptations, variations, alternatives and uses of the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the diagrams show in schematic, or omit, parts that are not essential in that diagram to a description of a particular feature, aspect or principle of the invention being disclosed. Thus, the best mode embodiment of one feature may be shown in one diagram, and the best mode of another feature will be called out in another diagram.

Operating Hour Interactive Dynamic System and Display

In general, the Operating Hour Interactive Dynamic System and Display of this application comprises an interactive system for dynamic, real-time display of operating hour information in a graphic format to users of internet linked computers and mobile devices. The system provides viewers with a grid model graphically representing a set of potential operating hours for an enterprise, where shaded regions on the grid model represent the enterprise's actual operating hours, and a dot-shaped icon depicts the current operating status for the enterprise. If the dot icon is positioned within the shaded regions, an end user looking at the display will immediately know the enterprise is currently open; if the icon is positioned outside the shaded regions, an end user will immediately know the enterprise is closed.

The system is programmed to compare the operating hour data (as depicted by the shaded regions on the grid model) with the current date and time data from programs on computers and other mobile devices, and graphically display the data for easy reference by an end user. The end user is not required to read text-based information for operating hours or to decipher that information as compared to clock times from an end user's watch or other available clock, if any. Instead, an end user (whether a potential customer, co-worker, subcontractor, personal contact or the like) glances at the graphic representation and immediately knows, without further effort, whether the enterprise is currently open for business. The operating hour display may be used as part of an errand running feature in which displays for multiple selected enterprises are superimposed on a map which may further include a suggested travel route prioritized on remaining open hours on that particular day and the relative locations of the enterprises.

A. Enterprise Data Entry Interface

a) Template for Enterprise-Specific Data Entry

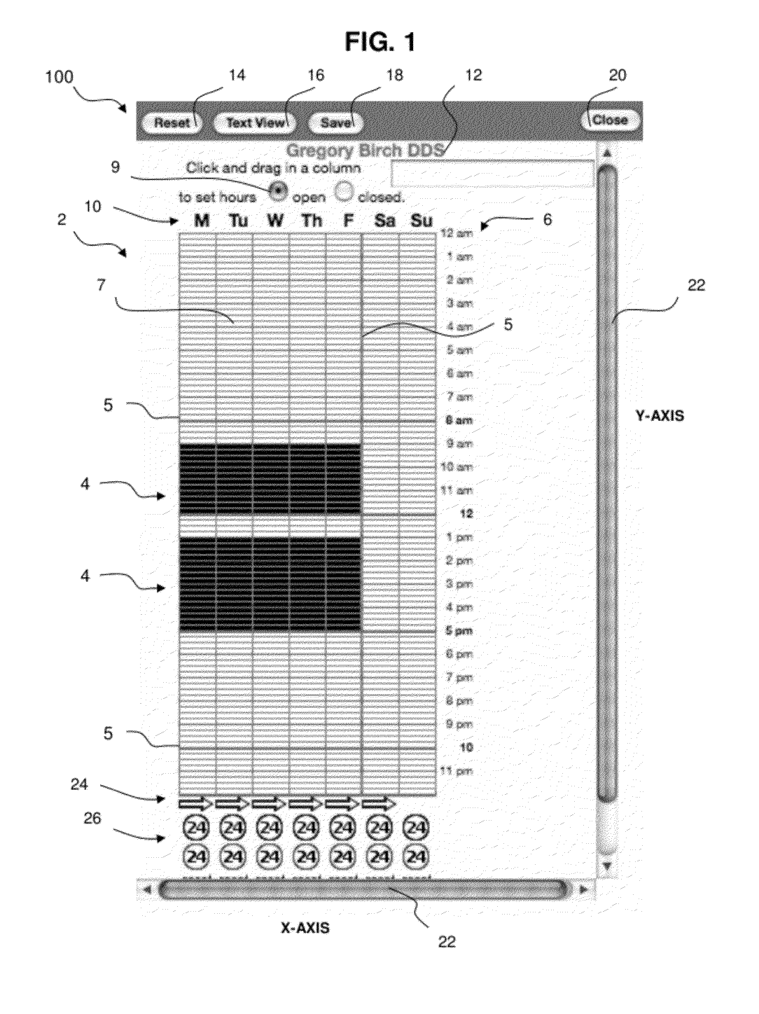

FIG. 1 shows an exemplary enterprise interface 100, according to the invention. For purposes of this application, the term “enterprise” is used to indicate any person or entity that operates an activity during certain hours or portions thereof in any medium. The term “enterprise” is to be construed as broadly as possible to include self-employed persons, small businesses, non-profit organizations, large corporations, franchise locations, schools, public agencies, malls, stadiums, concert promoters, political organizations, web-based companies, web-based service providers, blog writers, chat room participants, and any person(s) operating any activity that has a starting time and an ending time regardless of the nature, location or medium of the activity whether tangible or virtual.

Referring to FIG. 1, the interface 100 is a template for enterprise-specific data entry and comprises a grid model 2. The x-axis of the model 2 has seven columns 10, each column 10 representative of a day of the week, starting with Monday on the left margin and ending with Sunday on the right margin. The days are labeled at the top of the columns with abbreviated letters M, Tu, W, Th, F, Sa, Su, but may be represented in any suitable or desired manner. The y-axis of the model 2 has forty-eight rows 7, each row 7 representative of a 15 minute time increment. Each 60 minute hour 6, represented by four 15-minute rows 7, is listed in a column proximate to the right margin of the model 2. The hours are labeled, from top to bottom, 12 am through 11 am, 12 (noon), 1 pm through 9 pm, 10, and 11 pm. Any suitable or desired manner of listing the hours may be utilized. In addition, while the preferred embodiment is a two-dimensional grid model 2, it should be understood that any suitable graphic design for the grid model 2 may be utilized, including a grid model 2 and/or regions 4/7 within the model 2, having a three-dimensional appearance.

Referring to FIG. 1, bolded lines 5 run along the full length of the x-axis of the grid model 2 at 8 am, 12 noon, 5 pm and 10 pm to visually separate blocks of time during each day. The blocks of time are: early morning hours (12 am to 8 am) with a bolded line 5 crossing the grid model 2 at the 8 am time mark 6; regular morning hours (8 am to 12 noon) defined by bolded lines 5 at the 8 am and 12 noon time marks 6; afternoon hours (12 noon to 5 pm) defined by bolded lines 5 at the 12 noon and 5 pm time marks 6, early evening hours (5 pm to 10 pm) defined by bolded lines 5 at the 5 pm and 10 pm time marks 6, and late hours (10 pm to 12 midnight) defined by bolded lines 5 at the 10 pm and 12 midnight time marks 6. Any suitable or desired blocks of time may be highlighted on the grid model 2 using bolded lines 5 or other graphic features.

Referring to FIG. 1, shaded regions 4 are shown in the grid regions 7 representing 9 am to 12 noon, and 1 pm to 5 pm, on the y-axis, and Monday through Friday on the x-axis. The shaded regions 4 represent the times during which the operation (identified as Gregory Birch, DDS 12) is operating and otherwise open for business during the seven day week shown in the display 100. The shaded regions 4 provide a visual representation of the operating hours 4 at a glance and do not require reading text-based descriptions of the same information. The operating hours as depicted by the shaded regions 4 of FIG. 1 represent 9 am to 12 pm and 1 pm to 5 pm, Monday through Friday.

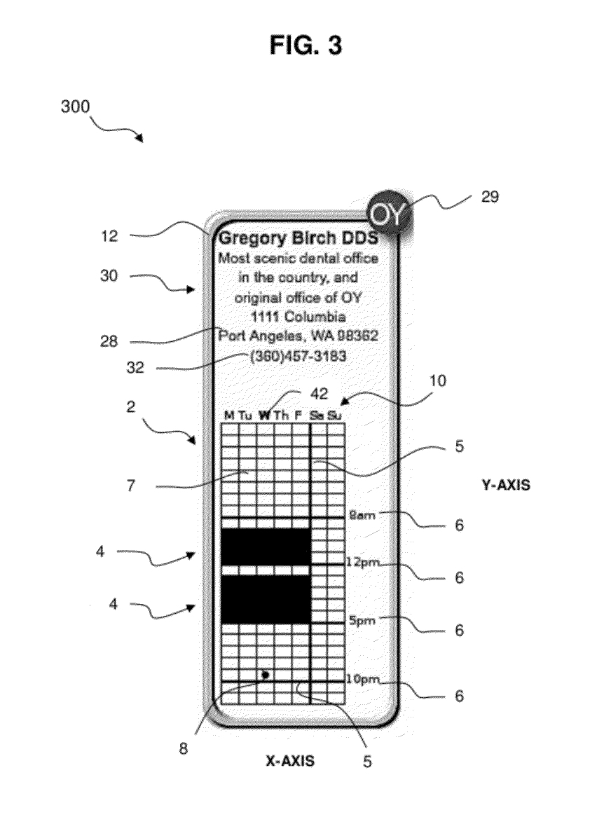

FIG. 1 shows an enterprise interface 100 that may be manipulated by a user to set the operating hours for that user's particular enterprise 12. The data is then saved 18 for viewing by others via the internet as further discussed in connection with FIGS. 3-7.

Referring to FIG. 1, a user accesses the interface 100 via the internet by logging onto a company website. The interface 100 is provided on the company website as a template. Alternately, the interface 100 may be “pushed” to a user via the internet for notification or update purposes. If the user is new to the company website, the user registers the enterprise 12 on the website by entering fields of information on an account sign-up website page. The user also sets a user name and password for the site. Once registered, the user is given access to the template 100 for data entry.

Referring to the grid model 2 of FIG. 1, the user directs a cursor (not shown) to activate the set hours open icon 9. The icon 9 is color coded blue when activated to indicate that the template 100 is ready to receive data regarding open hours. The user then directs the cursor over a region 7 at which operating hours would commence, and clicks the cursor and drags it downwards within the column 10 for the particular day of entry. As the cursor is dragged in a downwards direction, the regions 7 automatically fill to have a shaded appearance 4. When the user reaches a time on the grid 2 at which the operating hours cease, the user ceases to drag the cursor, and the shaded regions 4 end. Arrow icons 24 at the base of the grid model 2 when activated copy the operating hour regions 4 from one column 10 to the next across the course of the week represented in the grid 2. Two rows of twenty-four hour icons 26 are displayed beneath arrows 24. The twenty four hour icons 26 are circular with the number twenty four inside each circle. A top row of icons 26 is color-coded blue (for open); a second row of icons 26 is color-coded red (for closed). Activation of a blue twenty-four hour icon 26 under a particular column 10 automatically fills that column 10 with shaded regions 4 indicating open hours; activation of a red twenty four hour icon 26 under a particular column 10 automatically clears that column to indicate a lack of open hours.

Referring to FIG. 1, scroll bars 22 at the margin of the template 100 are manipulated along the x-axis and y-axis to assist in viewing the display 100 depending on the size of the screen available to the user. A header at the top of the display 100 contains operational and navigational icons, including reset 14, text view 16, save 18 and close 20.

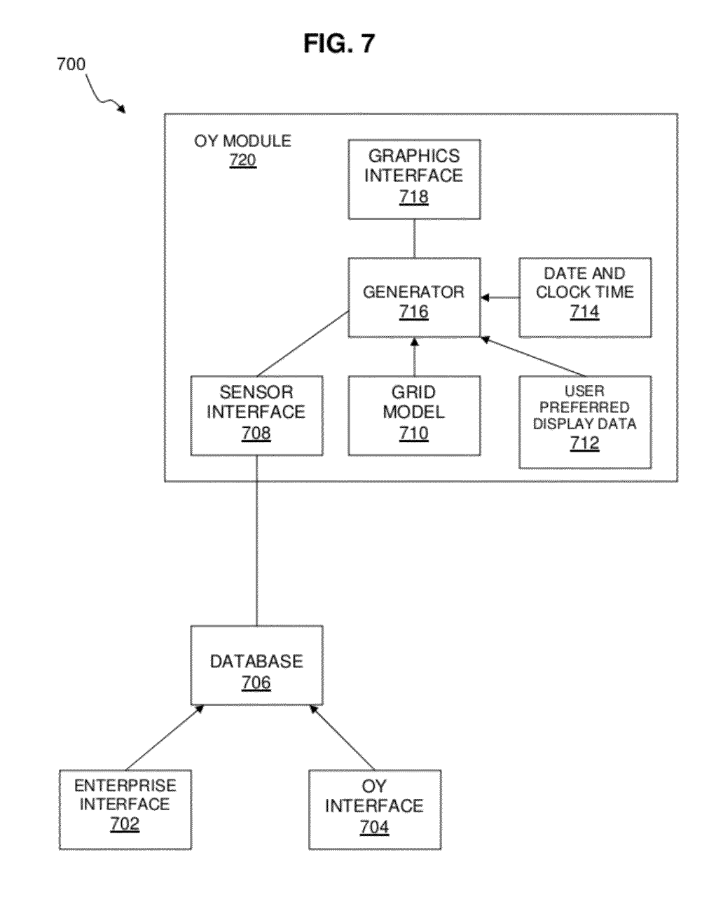

The grid model 2 is cleared by activating the reset icon 14. A text view icon 16 permits viewing of the operating hour information 4 in text-based format. A user may wish to confirm that the shaded regions 4 correspond to certain text-based information and may perform the confirmation by activating the text view icon 16. Upon activation, the data as entered in the grid model 2 is converted to text-based information for reading and review for accuracy. Once the user is satisfied that the data 4 is complete and accurate, the information is saved by activation of the save icon 18, and the template 100 is exited by activating the close icon 20. The data 4 is saved to a database accessible by modules capable of wireless internet connection, as further discussed in connection with FIG. 7.

c) Custom Data Entry

The template 100 may further include icons for entry of custom data, including, but not limited to, enterprise address, phone number, website link, trademarks, logos, slogans, photos, images, video clips, video links, and the like.

B. Third-Party Data Entry Interface

The interface 100 shown in FIG. 1 is designed to be utilized by enterprises 12 desiring to enter their own operating hour information 4 specific to their enterprise 12. However, the interface 100 also may be utilized by a third-party company to enter information about a particular enterprise 12 based on research conducted by the company. For example, a company named “OY” may conduct research to determine the operating hours 4 for particular entities 12 and will enter that information on the templates 100 without the entities' 12 involvement. The operating hour data 4 is collected by research conducted through on-line searches, by telephone contact, by reviewing telephone directory advertisements, and any automated and/or human processes available. Entry of the data 4 is achieved through any suitable or desired means, including: 1) the click and drag procedure described in connection with FIG. 1; 2) starting with pre-saved, partially entered templates 100 that are amended; and/or 3) entry of text and/or numerical data for automatic conversion to a graphic representation of shaded regions 4.

C. Method of Entering Operating Hour Data

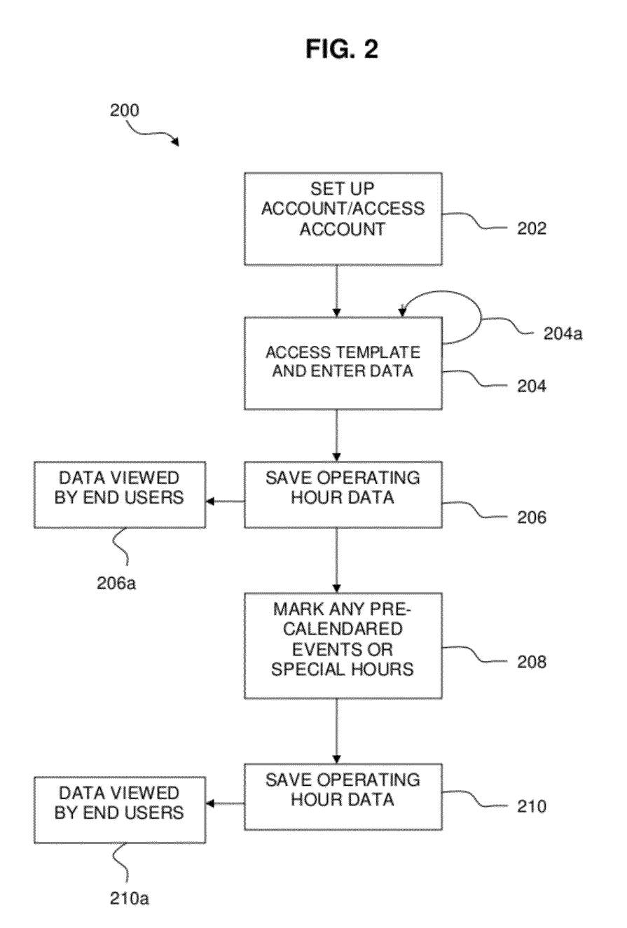

FIG. 2 is a flow diagram of a method for entering operating hour data 200 for an enterprise on an enterprise interface. In step 202, the enterprise accesses a third-party website to set up an account and accesses the account. Access to the account is password protected. In step 204, the enterprise enters data on the template as shown and described in connection with FIG. 1. In step 204a, the enterprise updates the data over time as changes to the standard operating hours arise. For example, the standard operating hours for the enterprise may change from 8 am to 5 pm, Monday to Friday, to 8:30 am to 5:30 pm, Monday through Thursday. The new and different hours are updated and graphically represented on the grid model 2.

Referring to step 206 of FIG. 2, the operating hour data is saved for viewing by others in step 206a. In step 208, the enterprise accesses a change function to alter operating hours for specific days or to set special hours within regular operating hours for particular days. In step 210, the altered data is saved for viewing by others in step 210a.

A third party company desiring to enter operating hour data for one or more entities without their involvement may follow the same general procedure starting with Step 202 of FIG. 2. The third party company may contract with entities to enter and display updated information as described in Step 208, or the method may end at Step 206a with updates made only to the full week operating hour schedule.

In the event that an account for an enterprise already has been created by a third-party company, and the enterprise desires instead to establish and control the representation of its own operating hour information, the enterprise may access the third-party website to set up a secure account and may then update or change the operating hour data as desired by following steps 204 through 210 of FIG. 2.

D. End User Interface

FIG. 3 shows an exemplary graphics interface 300 for an end user wanting to know operating hours 4 for a particular enterprise 12, where the data already has been entered according to FIGS. 1 and 2. The graphics interface 300 shown in FIG. 3 may be obtained over the internet in different manners, including: 1) direct access by the end user to a third-party website on which the graphic interface 300 is made available; or 2) by selection of the end user of the interface 300 as a “widget” on a website of the end user's personal choice.

1) Interface On Third-Party Website

Access to the graphic interface 300 on a third-party website is made by accessing either the public and/or secure pages of a third-party website. The website is programmed to provide public searches/inquiries as well as password protected secure account-based access.

Referring to FIG. 3, for a public search, an end user accesses the third-party website and is presented with a home page that comprises a series of tabs labeled “Home,” “Cities”, “Favorites” and “Search.” Upon activation of the “Cities” tab, the system is programmed to provide the viewer with a page containing a list of states and cities from which to choose. Upon activation of a particular city, such as Port Angeles, Wash., the system is programmed to display a page entitled Port Angeles, Washington containing a list of primary directory headings beneath the city name (“City Page”). Examples of primary directory headings for a City Page are: Art & Antiques, Associations & Nonprofits, Attractions, Automotive, and Bookstores. Displayed beneath the primary directory headings on the City Page are lists of secondary directory headings. For example, under the primary directory heading of Business & Professional Services are secondary directory headings of “Accounting, Auditing, Bookkeeping,” “Architectural Services,” “Banking and Finance Consultant”, “Business Consulting”, and so on.

Upon activation of a primary directory heading on the City Page, the system is programmed to present a Directory Page listing the primary heading, the secondary headings, and any specific enterprises that fall under the secondary headings. Proximate the listings on the Directory Page is a graphic representation of the grid model 2, an example of which is shown in FIG. 3. The system is programmed to display the grid model 2 for the operating hours for the enterprise at the top of the list presented on the Directory Page. The end user is prompted by text direction on the Directory Page to move the mouse (cursor) over the list of enterprises to view the grid model 2 representation of operating hours for the desired enterprises. The system is further programmed to automatically update/change the graphics 2 to represent the operating hours for whichever enterprise over which the mouse is “hovering” as directed by the end user.

Referring again to the City Page, the end user has the option of also activating a secondary directory heading (as opposed to a primary directory heading), to hone in on specific enterprises under a secondary directory heading and go directly to a Directory Page. In that event, the system is programmed to display a Directory Page of specific enterprises falling within the description for the secondary directory heading, only. The system is programmed to display a grid model 2 representing the operating hours for the enterprise at the top of the list presented on the Directory Page. The end user is prompted by text direction on the Directory Page to move the mouse (cursor) over the list of enterprises to view a graphic representation 2 of the operating hours for any desired enterprise in the list. The system is further programmed to automatically update/change the graphics 2 to represent the operating hours for whichever enterprise the mouse is “hovering” over as selected by the end user. In an alternate embodiment, the act of moving the mouse/cursor over the list of enterprise names causes a visual bar to appear between the activated enterprise and the corresponding grid model 2 on the display.

Referring to the grid model 2 shown in FIG. 3, the display comprises an x-axis with seven columns 10, each column representative of a day of the week, starting with Monday on the left margin and ending with Sunday on the right margin. The days are labeled at the top of the columns with abbreviated letters M, Tu, W, Th, F, Sa, Su. The y-axis of the model 2 has twenty-four rows 6, each row 6 representative of a one hour time increment in a twenty-four hour day. The hours 6 are labeled proximate to the right margin of the model 2 from top to bottom, 8 am, 12 pm, 5 pm, and 10 pm. Any suitable or desired manner of listing of hours may be utilized. In addition, while the preferred embodiment for a graphics interface 300 shown in FIG. 3 is two-dimensional, it should be understood that any suitable graphic design for the interface 300 and/or grid model 2 may be utilized, including a grid model 2 and/or regions 4/7 within the model 2 having a three-dimensional appearance.

Referring to the grid model 2 of FIG. 3, bolded lines 5 run along the full length of the x-axis 10 of the grid model 2 at 8 am, 12 pm, 5 pm and 10 pm to visually separate blocks of time during each day. Any suitable or desired blocks of time may be highlighted on the grid model 2 using bolded lines 5 or other graphic features.

Referring to the grid model 2 of FIG. 3, shaded regions 4 are shown in the grid regions 7 representing 9 am to 12 pm, and 1 pm to 5 pm, on the y-axis, and Monday through Friday on the x-axis. The shaded regions 4 represent the times during which the operation (identified as Gregory Birch DDS 12) is operating and otherwise open for business during the week shown in the display 300. The shaded regions 4 provide a visual representation of the operating hours 4 at a glance and do not require reading text-based descriptions of the same information. The operating hours as depicted by the shaded regions 4 of FIG. 3 represent 9 am to 12 pm and 1 pm to 5 pm, Monday through Friday.

Referring to the grid model 2 of FIG. 3, a circular dot-shaped icon 8 is shown proximate the bottom margin of the grid model 2 in a region 7 representing a Wednesday between 9 and 10 pm. The “W” 42 representing Wednesday proximate the top of the grid 2 is bolded. The system is programmed to bold the day of week in which the end user is viewing the interface 300. The dot icon 8 shown in FIG. 3 represents the day of the week and time of the day in which the end user is currently viewing the interface 300. The dot icon 8 represents the day and time of the end user, which the end user can compare visually to the shaded regions 4 to determine at a glance whether the enterprise 12 is currently open or closed. If the icon 8 is positioned outside of the shaded regions 4, the enterprise 12 is closed; if the icon is positioned within the shaded regions 4, the enterprise 12 is currently open. No reading of text-based information is necessary or required to make the determination of whether the enterprise 12 is currently open or closed; rather, the end user may glance at the grid model 2 and see whether the dot icon 8 is in a region 7 that is outside the shaded regions 4 (closed), or inside the shaded regions 4 (open).

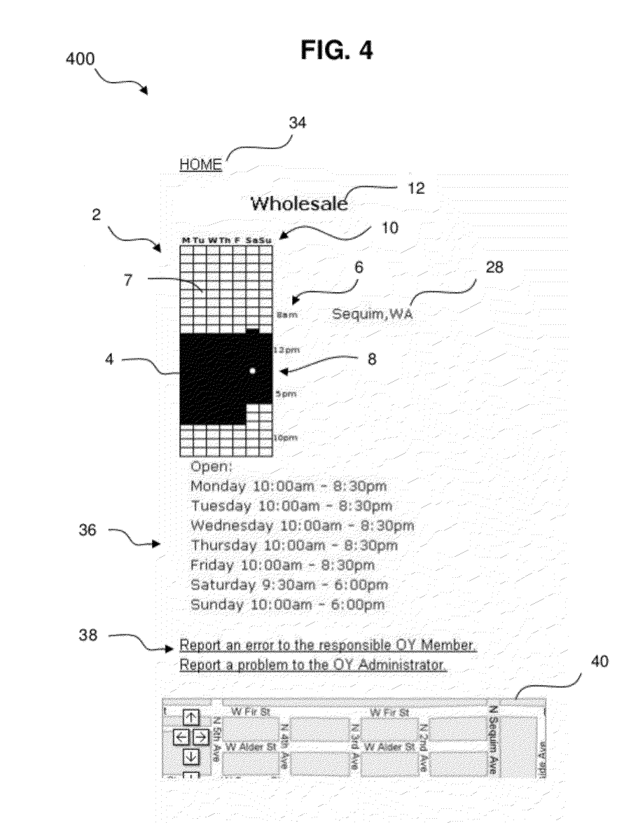

In the event the dot icon 8 is located within the shaded regions 4 (meaning the enterprise 12 is open at the time the end user is viewing the grid model 2), the dot icon 8 will be colored white instead of black so as to visually stand out from the shaded regions 4 (shown in FIG. 4). Whether located within or outside the shaded regions, the icon 8 is distinguished from the shaded regions 4 by color or pattern or other distinguishing feature. For example, the system may be further programmed to assign a color and/or other shape (such as a pulsating three-dimensional orb appearance) to the icon 8 to represent open versus closed status for the enterprise 12. Any desired or suitable use of color, pattern, or other distinguishing feature in one or more icons may be utilized to graphically represent the current time versus the graphic representation of operating hours for the enterprise 12.

Referring to FIG. 3, the interface 300 may further comprise the entity name 12, an entity slogan 30, the entity address 28, and the entity's phone number 32. The detailed data may be entered by the enterprise as part of the account set-up discussed in connection with FIGS. 1 and 2 to create a detailed interface 300. As discussed in connection with FIG. 1, alternately, the template 100 may include icons for activation and entry of custom data, including, but not limited to, enterprise address, phone number, website link, trademarks, logos, slogans, photos, images, video clips, video links, and the like, to produce a detailed graphics interface 300.

FIG. 4 shows an alternate exemplary graphics interface 400 according to the invention. FIG. 4 is an alternate example of a display to an end user upon searching the operating hours for a particular enterprise 12. Visually displayed in the grid model 2 for FIG. 4 are the operating hours 4 for the enterprise 12 of Monday through Friday, 10 am to 8:30 pm, Saturday 9:30 am to 6:00 pm and Sunday 10:00 am to 6:00 pm. An end user viewing the interface 400 will see, at a glance, that the enterprise 12 is currently open because the dot icon 8 is positioned within the shaded regions 4 for that enterprise

The interface 400 of FIG. 4 differs from the interface 300 shown in FIG. 3 in several respects. As previously discussed, the interface 300 shown in FIG. 3 includes custom data such as a slogan 30, address 28 and telephone number 32. The interface 400 of FIG. 4 is standard and has not been customized by the enterprise 12. The interface 400 of FIG. 4 represents an example of a standard display 400 based on entry of data by a third-party company, as opposed to customized entry of data by the enterprise 12 itself. The standard display 400 includes text-based operating hour data 36, administrative links 38, and a map 40. The text-based operating hour data 36 is programmed to be color-coded to provide additional visual cues as to whether the enterprise is open. In the preferred embodiment, blue text indicates the enterprise is open; red text indicates the enterprise is closed. While the data shown on the standard display 400 of FIG. 4 is limited, it should be understood that any suitable or desired non-proprietary data may be included on a standard display 400 including, but not limited to, enterprise address, phone number, website link, photos, images, video clips, video links, and the like.

2) Widget Interface On End User's Chosen Website

Referring back to FIG. 3, the interface 300 for a particular enterprise may alternately be displayed as a widget on a website of the end user's choice. FIG. 3 shows an exemplary graphic format for such a widget. Widgets are embeddable sets of programming code that are selectively embedded within a page of Hypertext Markup Language, such as on a web page or on a hand-held mobile device. Widgets add non-static content to a web page. Widgets may be added to home page sites such as IGOOGLE® and YAHOO®. The code allows for downloading of “live” content, including advertisements, links, and images, from a third party site without the site owner having to update or control the code. Web users generally use widgets to enhance their personal web pages with information they seek out and want to have readily available. Mobile web widgets are widgets that are made or designed for access on mobile devices. The exemplary widget 300 shown in FIG. 3 includes an icon labeled “OY” 29 which upon activation links the end user to the OY (third party company) website.

Referring again to FIG. 4, the graphics interface 400 may include a link 38 for creating a widget on the end user's chosen website page, such as a home page that the end user typically refers to during a work day. The link 38 provides the code for the widget to copy and place on a website page of the end user's preference. The end user copies and pastes the widget to the website page. For example, if an end user works with several suppliers around the globe and wants to know at any particular time of day which suppliers are open for business, the end user may create a series of widgets, one for each supplier, on a preferred website page for quick and convenient reference throughout the work day.

3) Alternate Embodiments of End User Interface

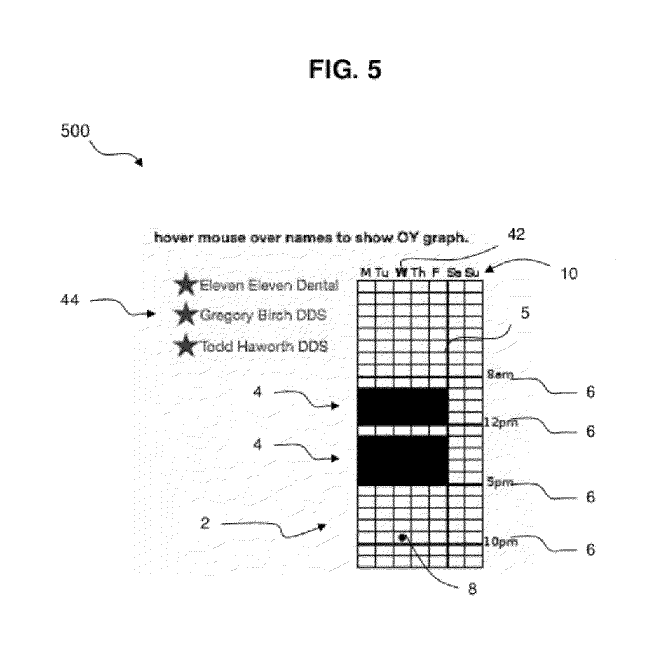

FIG. 5 shows a second alternate embodiment of an end user interface 500 that includes display of operating hour data 4 for select enterprises 12 that have been previously labeled as “favorites” 44. The system is programmed to display a graphics interface permitting pre-selection of at least one specified enterprise 44 for automatic viewing each time the grid is presented. This selection of “favorites” 44 allows end users to identify enterprises 12 for immediate viewing of the grid models 2. For example, an end user may frequent certain shopping locations on a semi-regular basis, and may not want to navigate through the website to find particular enterprises each time the end user logs onto the third party website. In that event, the end user may: 1) set up a secure account with the third party website; 2) navigate the website to locate the enterprise(s) of frequent visitation; 3) activate a star-shaped icon proximate each such enterprise 44; 4) thereafter, navigate directly to the “Favorites” page for the end user and have access to just those grid models 2; 5) direct the mouse/cursor over the desired enterprise 12 within a list of favorites 44 for automatic display of the grid model 2 for that enterprise; 6) move (“hover”) the mouse/cursor over other favorites 44 in the list to determine out of the list of locations to visit, which one(s) are currently open.

In this manner, the end user may utilize the favorites list 44 to visually review the grid models 2 for multiple entities at one time to compare and contrast the grid models 2 for trip planning purposes. No reading of text-based operating hour information or other inquiries is required. The end user readily sees whether the dot icon is located in the shaded regions; may compare the location of the dot icons amongst the list of favorites to determine which favorites will be open during the planned trip, and for how long; and can plan a trip to multiple locations accordingly.

E. System Method

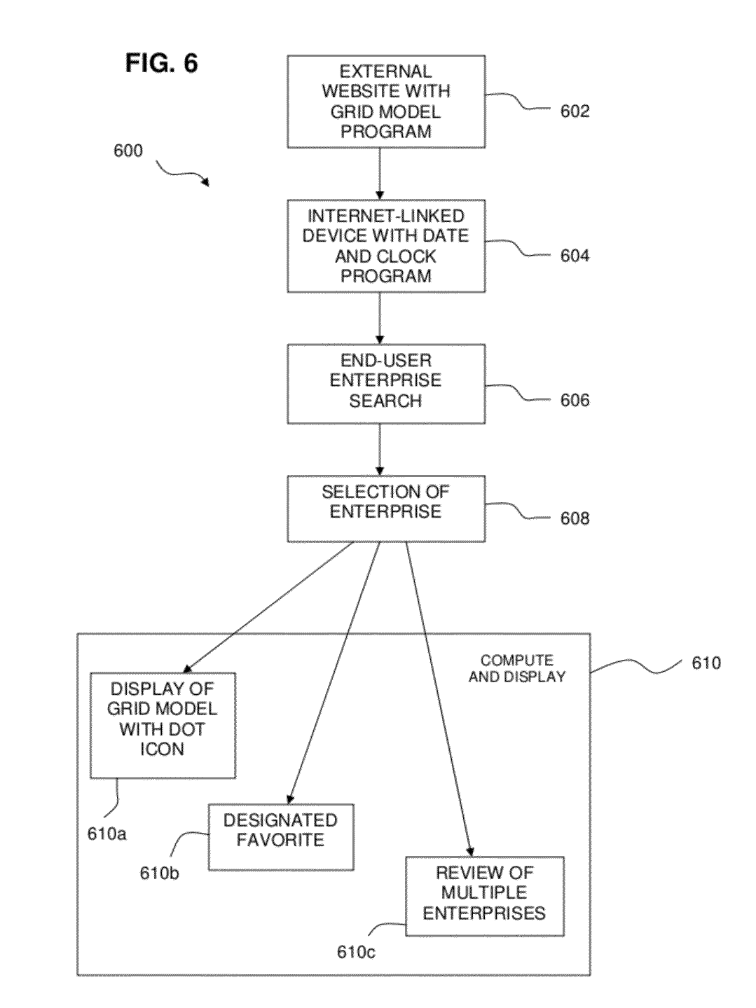

FIG. 6 is a flow chart for a method of performing a search for operating hour data on the system by an end user 600, according to the invention. In Step 602, operating hour data is entered into a grid model template as described in connection with FIGS. 1 and 2. The operating hour data may be entered by the enterprise itself or a third-party company. The data may be entered over the internet via the third-party company's website, or through direct input to a database. A program capable of generating the grid model with operating hour data is downloaded to the third-party website accessible by personal computer or mobile device. Alternately, the program may be downloaded directly to a personal computer or mobile device, such as a phone, SMART PHONE®, IPOD®, IPHONE®, G1 ANDROID®, personal desk assistant or other mobile or hand-held device.

In Step 604 of FIG. 6, the program is coded to link the grid model representation to the current date and time as calculated/sensed by the computer or mobile device. In Step 606, an end user accesses the third-party website and navigates the site to select a particular enterprise 12 as discussed in connection with FIGS. 3-5. In Step 608, the end user selects a particular enterprise 12 for viewing, and the program senses the date and time data for entry on the display as represented by the dot icon.

In Step 610, the computer or device computes the grid model 2 and displays the model 2. In Step 610a, the computer displays the grid model 2 with dot icon 8 positioned at a day and time on the grid model 2 representative of the current day and time of the week in which the end user is viewing the model 2. In Step 610b, the end user has the option of saving the enterprise 12 in his/her list of favorites for faster access. In Step 610c, the operating hour data comprises a first mapping of operating hours of a first enterprise, and the operations further comprise graphically representing operating hours of a second enterprise by receiving a second mapping and substituting the second mapping for the first mapping while retaining the grid model. Alternately, the end user may exit a first grid model 2 for one enterprise 12, navigate the website to find operating hour models 2 for other enterprises 12, and activate other grid models 2 for viewing.

The method may further comprise the steps of comparing the operating hour data for an enterprise 12 located in a first time zone to a location of an end user in a second time zone and generating a presentation of the model 2 that displays the current operating status of the enterprise 12 consistent with the first time zone. This feature may be utilized in connection with the previous example of an end user working with several suppliers around the globe. If the end user desires to know at any particular time of day which suppliers are open for business, the end user accesses one or more grid models that plot the dot icon on the operating hours relative to the enterprise in the first time zone, as opposed to plotting the dot icon relative to the end user's current date and time in the second time zone. In this manner, the end user determines at a glance whether the supplier is open for business in that supplier's time zone.

F. System Configuration

FIG. 7 is a block diagram of the system's configuration 700 according to the invention. Starting at the base of FIG. 7, the system 700 comprises an enterprise interface 702 made available on a website for entry of operating hour data for the enterprise. As discussed in connection with FIGS. 1 and 2, the interface 702 includes a template for enterprise-specific data entry on a grid model 2.

Referring to FIG. 7, the operating hour data also may be entered via an OY interface 704 accessible by a third-party company. The OY interface 704 is utilized for entering operating hour data based on research conducted by the third-party company or other persons/entities. The third-party company enters the operating hour data on templates without the entities' involvement. Entry of the data is achieved through any suitable or desired means, including: 1) the click and drag procedure described in connection with FIG. 1; 2) starting with pre-saved, partially entered grid regions that are then amended; and/or 3) entry of text and/or numerical data for automatic conversion to a graphic representation of shaded regions. The data collected through the enterprise interface 702 and OY interface 704 is saved to a database 706 where it is maintained and updated periodically.

Referring to FIG. 7, the OY module 720 is any device or apparatus capable of presenting the graphics interface 718 with grid model of operating hours. The module 720 is a personal computer or mobile device, such as a phone, SMART PHONE®, IPOD®, IPHONE®, G1 ANDROID®, personal desk assistant, or other mobile or hand-held device having a screen display or equivalent. The OY module 720 is capable of interfacing with the database 706 over the internet via a sensor interface 708. The internet connection can be via cable, telephone line and/or wireless. In the preferred embodiment, the grid model 710 and generator program 716 are downloaded to the OY module 720 and are maintained on the OY module 720. The OY module 720 further has a date and clock time program 714 downloaded to the module 720.

Referring to FIG. 7, upon selection of an enterprise for display of operating hour data by a user, a graphics generator program 716 receives and analyzes operating hour data from the database 706 for that particular enterprise via the sensor interface 708. The operating hour data is communicated to the generator program 716 which is programmed to apply the data to the grid model 710 for display on the graphics interface 718. The graphics generator 716 comprises an application program resident in at least one module 720 for generating and displaying at least one grid model on an electronic screen display.

In an alternate embodiment, access to the operating hour data is limited to identified private users and/or select OY modules 720. An enterprise may limit access of operating hour information to certain identified persons/entities when entering the data at the interface 702. When the database 706 is queried, the operating hour data is provided only to those private users with identified access.

Referring to FIG. 7, the graphics generator 716 further calculates and assigns a position for the dot icon for display on the graphics interface 718 relative to the grid model 710 based on a second sensor that receives and analyzes the current date and clock time 714. If an end user enters user preferred display data 712 (such as selection of certain enterprises as “favorites” for immediate viewing upon activation of the generator program 716), the graphics interface 718 receives and analyzes that data and the graphics generator 716 modifies the interface 718 accordingly.

In an alternate embodiment, the grid model 710 code is contained in the database 706 as opposed to being downloaded to the module 720 with the graphics generator 716. It should be understood that any suitable or desired configuration may be employed to provide and display the graphics interface 718 to an end user according to this invention.

G. Errand Running Feature

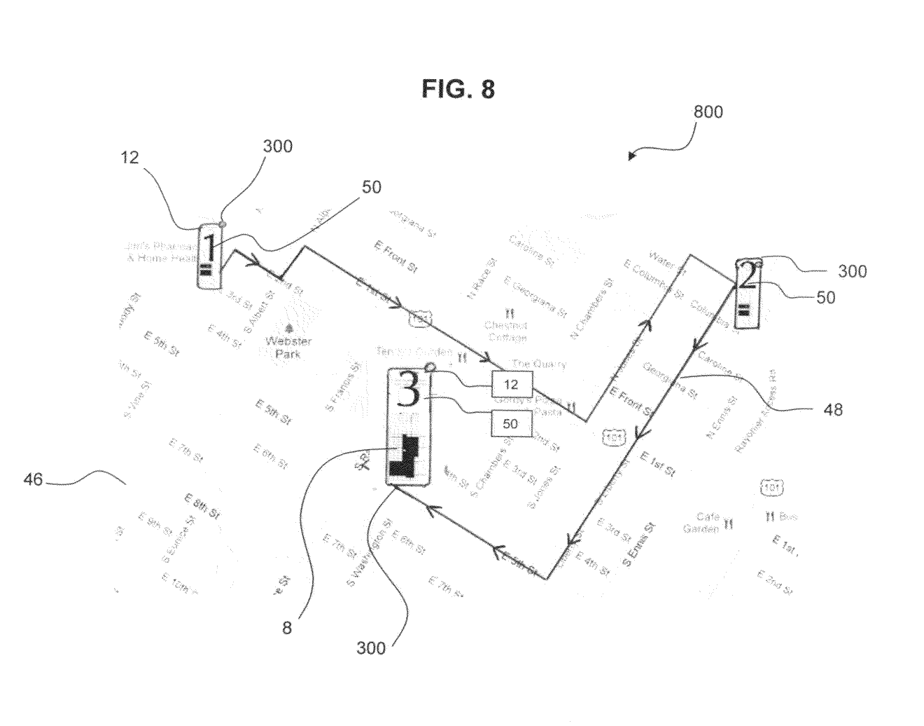

FIG. 8 shows an exemplary errand running display 800. Referring to FIG. 8, the system may be further programmed to superimpose one or more presentations of the operating hours 300 on a map 46. The operating hour displays 300 are positioned proximate the location for each enterprise 12 on the map 46.

Referring to FIG. 8, the errand running display 800 may further comprise a suggested travel route 48 with each operating hour display 300 assigned an errand priority number 50 (for example, numbers 1, 2 and 3). The route 48 and priority numbers 50 are determined by a comparison of the location of the user, on the one hand, and a location and a set of remaining operating hours for the one or more selected enterprises 12 for the current day of the week and clock time, on the other hand. Upon identification of one or more destinations as part of an errand trip (via highlighting or other mode of selection), the user is provided with a suggested route 48 based on remaining operating hours and proximity of the user relative to the locations of the enterprises 12.

Referring to FIG. 8, as an example, if the destination having the travel priority 50 number 3 closes at a later hour than the entities 12 assigned travel priorities 50 numbered 1 or 2, the errand feature calculates and displays a suggested route 48 that places destination 3 at the end of the trip. Destination 1 is chosen for its proximity to the user. Destination 2 is chosen as the next destination because it closes earlier than destination 3.

Referring again to FIG. 8, destination 3 is shown enlarged because a user has moved a cursor over it for viewing. As shown in FIG. 8, even though the grid model 2 for destination 3 is small when viewed, the icon 8 representing the current time relative to the set of operating hours for the enterprise 12 is readily visible as a white circular dot against the shaded regions. At a glance, the user can compare the current time (white circular dot icon 8) to the amount of operating time for the entity 12 remaining for that particular day without reference to a location of the enterprise, the location of the user, a calendar, a date or a clock.

### INDUSTRIAL APPLICABILITY

It is clear that the inventive Operating Hour Interactive Dynamic System and Display of this application has wide applicability to all business and customer-oriented industries, namely to provide updated, accurate information in real time about open hours utilizing universally understandable graphics that do not require the reading of text or text analysis or the comparison of text-based information to independent time and date sources.

It should be understood that various modifications within the scope of this invention can be made by one of ordinary skill in the art without departing from the spirit thereof and without undue experimentation. For example, the grid model may be modified in shape or design. The grid model may comprise an x-axis representing a single, current day of the week, with a y-axis comprising a series of 24 regions representing hours in the current day. The shaded regions indicating times during which the entity is open for business may be distinguished in any suitable or desired manner; the icon depicting the current operating status may be any suitable or desired shape or color; the graphics interface may include additional features such as links to the entity's website or phone links for calling the entity from a PC or mobile device. This invention is therefore to be defined as broadly as the prior art will permit, and in view of the specification if need be, including a full range of current and future equivalents thereof.

I claim:

1. An apparatus for graphically displaying dynamic operating hour data, comprising:
a grid model to graphically represent a set of potential operating hours of an enterprise, said grid model comprising a representation of one or more days in a week;
a depiction of shaded regions superimposed on the grid model, each region distinguished from others by color or pattern or other distinguishing feature, each region representative of at least one operating hour;
an icon depicting a current operating status for the enterprise, wherein a position of the icon on the grid model is representative of a current day of the week and clock time relative to the shaded regions, said position further representative of a comparison of the operating hour data for the enterprise located in a first time zone to a location of a user in a second time zone;
a sensor interface to receive the operating hour data;
a graphics generator to prepare a presentation of the grid model and icon according to the data as correlated to the current day of the week and clock time, said presentation displaying the current operating status of the enterprise consistent with the first time zone; and,
whereby a user makes a determination of the current operating status of the enterprise upon a viewing of the position of the icon relative to the shaded regions, said determination made capable without a reference by the user to the group consisting of: the first time zone, the second time zone, a location of the enterprise, the location of the user, a calendar, a date, and a clock.

2. The apparatus of claim 1, wherein the grid model comprises an x-axis and a y-axis, the x-axis comprising a series of 7 regions representative of days in a week, and the y-axis comprising a series of 24 regions representative of hours in a day.

3. The apparatus of claim 1, wherein the grid model comprises an x-axis and a y-axis, the x-axis comprising a region representative of a current day of the week, and the y-axis comprising a series of 24 regions representative of hours in the current day.

4. The apparatus of claim 1, wherein the icon comprises a circular dot distinguished from the shaded regions by an absence of color when superimposed on the regions.

5. The apparatus of claim 1, wherein the first and second time zones are identical.

6. The apparatus of claim 1, wherein the first and second time zones are different.

7. The apparatus of claim 1, wherein the sensor interface comprises a first sensor to receive and analyze the operating hour data, and a second sensor to receive and analyze the day of the week and clock time data.

8. The apparatus of claim 1, wherein the graphics generator comprises an application program resident in at least one computer for generating and displaying at least one model on at least one electronic screen display.

9. The apparatus of claim 1, wherein the graphics generator comprises a graphics interface to receive and analyze a set of user preferred display data.

10. The apparatus of claim 1, wherein the graphics generator comprises a graphics interface permitting pre-selection of at least one specified enterprise for automatic viewing each time the grid is presented.

11. The apparatus of claim 1, wherein the presentation of the grid model and icon is superimposed on a map display, a position of said presentation proximate a location for the enterprise on the map.

12. The apparatus of claim 1, wherein the presentation of the grid model and icon comprises a suggested travel route superimposed on a map display, said route determined by a comparison of the location of the user, on the one hand, and a location and a set of remaining operating hours for one or more selected enterprises for the current day of the week and clock time, on the other hand.

13. A non-transitory computer readable storage media containing a program to perform operations to graphically display dynamic operating hour data, the operations comprising:
providing a grid model comprising a representation of one or more days in a week to graphically represent a set of potential operating hours of an enterprise as follows:
a depiction of shaded regions superimposed on the grid model, each region distinguished from others by color or pattern or other distinguishing feature, each region representative of at least one operating hour;
an icon depicting a current operating status for the enterprise, wherein a position of the icon on the grid model is representative of a current day of the week and clock time relative to the shaded regions, said position further representative of a comparison of the operating hour data for the enterprise located in a first time zone to a location of a user in a second time zone;
receiving operating hour data from a sensor interface;
operating a graphics generator to prepare a presentation of the grid model and icon according to the operating hour data as correlated to the current day of the week and clock time, said presentation displaying the current operating status of the enterprise consistent with the first time zone; and,
whereby a user makes a determination of the current operating status of the enterprise upon a viewing of the position of the icon relative to the shaded regions, said determination made capable without a reference by the user to the group consisting of: the first time zone, the second time zone, a location of the enterprise, the location of the user, a calendar, a date, and a clock.

14. A computer implemented method of graphically displaying dynamic operating hour data, comprising operations of:
providing a grid model comprising a representation of one or more days in a week to graphically represent a set of potential operating hours of an enterprise as follows:
a depiction of shaded regions superimposed on the grid model, each region distinguished from others by color or pattern or other distinguishing feature, each region representative of at least one operating hour;
an icon depicting a current operating status for the enterprise, wherein a position of the icon on the grid model is representative of a current day of the week and clock time relative to the shaded regions, said position further representative of a comparison of the operating hour data for the enterprise located in a first time zone to a location of a user in a second time zone;
receiving operating hour data from a sensor interface;
operating a graphics generator to prepare a presentation of the grid model and icon according to the operating hour data as correlated to the current day of the week and clock time, said presentation displaying the current operating status of the enterprise consistent with the first time zone; and,
whereby a user makes a determination of the current operating status of the enterprise upon a viewing of the position of the icon relative to the shaded regions, said determination made capable without a reference by the user to the group consisting of: the first time zone, the second time zone, a location of the enterprise, the location of the user, a calendar, a date, and a clock.

15. The method of claim 14 further comprising the steps of:
maintaining a database of operating hour data; and,
receiving operating hour data to be maintained on the database from an enterprise interface.

16. The method of claim 14, wherein the first and second time zones are identical.

17. The method of claim 14, wherein the first and second time zones are different.

18. The method of claim 14, wherein the receiving step comprises identification of a set of private users to which the operating hour data access is limited.

19. The method of claim 14, further comprising the step of superimposing the presentation of the grid model and icon on a map display, a position of said presentation proximate a location for the enterprise on the map.

20. The method of claim 14, further comprising the step of superimposing a suggested travel route on a map display, said route determined by a comparison of the location of the user, on the one hand, and a location and a set of remaining operating hours for one or more selected enterprises for the current day of the week and clock time, on the other hand.
